(19) United States
(12) Patent Application Publication
(10) Pub. No.: US 2005/0008932 A1
(43) Pub. Date: Jan. 13, 2005

(54) Fluid supply device for electrochemical cell

(76) Inventor: Lawrence R. Plotkin, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/617,547

(22) Filed: Jul. 10, 2003

(51) Int. Cl. H01M 6/30; H01M 8/00

(52) U.S. Cl. 429/118; 429/72; 429/34; 429/13

(57) ABSTRACT

A device which includes an electronically controllable drop ejector adapted to be in communication with an electrochemical cell. The electronically controllable drop ejector conveys measured quantities of a chemical composition capable of oxidative reaction together with other associated compositions into the electrochemical cell.

The present disclosure is related to fluid delivery systems which can be employed with electrochemical devices such as, for example, fuel cells and batteries.

### BACKGROUND OF THE INVENTIONS

Electrochemical cells, such as fuel cells and batteries, convert a fuel material, typically a chemical or chemical composition capable of oxidative reaction, into electricity and reaction product(s). Electrochemical cells have significant advantages in that they possess relatively high energy density and are not hampered by lengthy recharging cycles. Electrochemical cells are also relatively small, lightweight and produce minimal amounts of undesirable environmental emissions. Electrochemical cells and systems which employ the same can be advantageously improved by the inclusion of efficient and effective systems for delivery of fuels and/or other materials necessary for the functioning of the electrochemical cell. The inventor herein has determined that it would be advantageous to provide improved systems for delivering the chemical material or composition(s) (fuel) to appropriate locations in the electrochemical cells such as fuel cell anodes.

### SUMMARY OF THE INVENTION

Disclosed is a device which includes an electronically controllable drop ejector adapted to be associated with an electrochemical cell. The electronically controllable drop ejector is capable of conveying measured quantities of a chemical composition capable of oxidative reaction into the electrochemical cell.

### BRIEF DESCRIPTION OF THE DRAWINGS

FIG. 1A is a schematic depiction of a fluid supply device configuration according to an embodiment discussed herein;

FIG. 1B is a schematic depiction of a fluid supply configuration according to an additional embodiment discussed herein;

FIG. 1C is a schematic depiction of a fluid supply device configuration according to an additional embodiment discussed herein;

FIG. 2A is a diagrammatic view of an exemplary electrochemical cell and fluid supply device of FIG. 1A;

FIG. 2B is a diagrammatic view of an exemplary electrochemical cell and fluid supply device of FIG. 1B;

FIG. 2C is a diagrammatic view of an exemplary electrochemical cell and fluid supply device of FIG. 1C;

FIG. 3 is a schematic view of an exemplary electrochemical cell;

FIG. 4 is a diagrammatic view of an alternate exemplary electro-chemical cell;

FIG. 5A is an exploded view of an anode in the exemplary electrochemical cell of FIG. 4;

FIG. 5B is an exploded view of a cathode in the exemplary electrochemical cell of FIG. 4;

FIG. 5C is an exploded view of an ion exchange membrane in the exemplary electrochemical cell of FIG. 4;

FIG. 6 is a diagrammatic view of an electrochemical cell in accordance with an embodiment as discussed herein;

FIG. 7 is a diagrammatic view of a drop ejection mechanism in accordance with an embodiment as discussed herein;

FIG. 8 is schematic view of a drop ejection mechanism and process stream in accordance with an embodiment as discussed herein;

FIG. 9 is a perspective view of a cartridge member in accordance with an embodiment as discussed herein;

FIG. 10 is a perspective view of a nozzle member with catalytic resistor;

FIG. 11 is a process diagram of a fluid supply method; and

FIG. 12 is a process diagram of a method for initiating chemical reaction.

### DETAILED DESCRIPTION OF EMBODIMENTS

The following is a detailed description of the best presently known modes of carrying out the inventions. This description is not to be taken in a limiting sense, but is made merely for the purpose of illustrating the general principles of the inventions. It is noted that detailed discussions of electrochemical cell structures that are not pertinent to the present inventions have been omitted for the sake of simplicity.

The present inventions are also applicable to a wide range of electrochemical cell technologies, particularly a wide range of fuel cell technologies, including those presently being developed or yet to be developed. Thus, although various exemplary fuel cell systems are described, such as direct methanol fuel cells (DMFC), other proton exchange membrane (PEM) fuel cells, other types of fuel cells such as solid oxide fuel cells and the like are considered applicable.

As disclosed herein, the electrochemical cell fluid supply device includes at least one electronically controllable drop ejection device capable of conveying quantities of a chemical composition capable of oxidative reaction into an electrochemical cell. As embodied and contemplated, the electronically controllable drop ejection device is in communication with the electrochemical cell in a manner whereby the chemical composition is introduced either directly or indirectly into contact with the electrochemical cell. The construction disclosed herein may include a single electronically controllable drop ejection device or multiple drop ejection devices which discharge one or multiple components according to an appropriate firing command. The electronically controllable drop ejection device may be configured to discharge material(s) from one or multiple chambers. The material(s) may be delivered directly into contact with anode(s) of an electrochemical cell in the desired delivery pattern(s) and/or in amount(s) required or desired to a suitable intermediate stream or device prior to introduction into contact with anode(s) in a closed loop system.

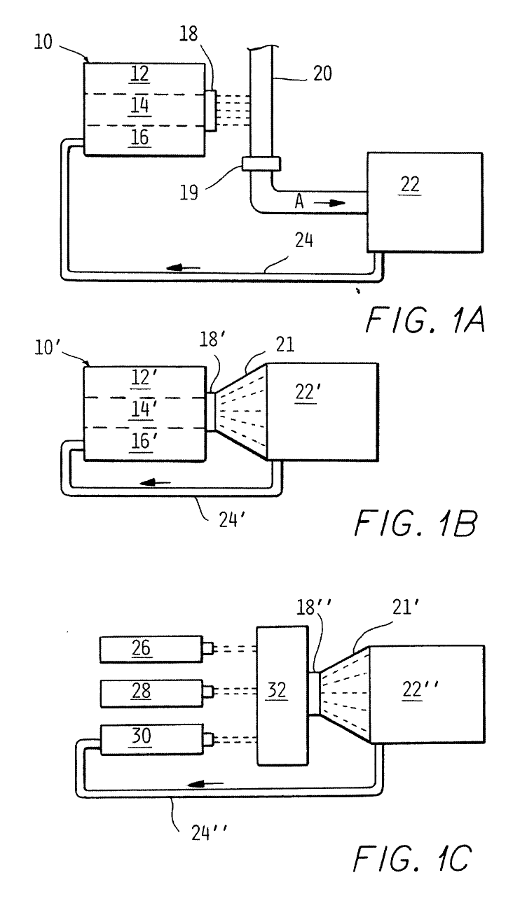

One contemplated configuration for an electrochemical cell fluid supply device is depicted in FIG. 1A in which an electronically controllable drop ejection device 10 having chambers 12, 14, 16 is oriented to discharge material(s) through an electronically controllable head 18 into a conduit 20. The conduit 20 is connected to the electrochemical cell 22 in a manner which permits effective delivery. Conduit 20 can include a suitable mixer 19 located down stream of the material introduction point. At least one byproduct of the electrochemical process that occurs in the electrochemical cell 22 is conveyed from the electrochemical cell 22 through a suitable conduit such as conduit 24 into a suitable chamber in the electronically controllable drop ejection device such as chamber 16 for reintegration into the delivery stream. The conveyed byproduct can be reintegrated into the delivery stream at a proportion of ratio suitable for supporting the electrochemical reaction occurring in the cell 22.

An alternative delivery configuration is depicted in FIG. 1B in which an electronically controllable drop ejection device 10′ having chambers 12′, 14′, 16′ is oriented to discharge material(s) through an electronically controllable head 18′ into an electrochemical cell 22′ via a baffle 21 which directs the ejected material(s) into contact with the electrochemical cell 22′. At least one byproduct of the electrochemical process that occurs in the electrochemical cell 22′ is conveyed from the cell 22′ through a suitable conduit such as conduit 24′ into a suitable chamber in the drop ejection device 10′ such as chamber 16′ for reintegration into the delivery stream. The conveyed byproduct can be reintegrated into the delivery stream at a proportion suitable for supporting electrochemical reaction occurring in the cell 22′.

An additional alternative delivery configuration is depicted in FIG. 1C in which multiple fluid delivery devices such as devices 26, 28, 30 can deliver various materials in an appropriate proportionate manner. The materials are delivered to a suitable admixer 32 in any suitable manner. After residence in the admixer 32, the admixed materials are delivered to an associated electrochemical cell 22″ as through injector head 18″ through buffer 21′. At least one byproduct of the electrochemical process occurring in the electrochemical cell 22″ is conveyed from the cell 22″ to at least one of the fluid delivery devices 26, 28, 30 through conduit 24″.

Admixer 32 as disclosed herein is an electronically controllable ejection device having a suitable head such as head 18″. It is contemplated that the fluid delivery devices 26, 28, 30 can be any device capable of providing controlled delivery of the associated material in a proportionate manner. Suitable devices can include electronically controllable fluid delivery devices such as drop ejection devices.

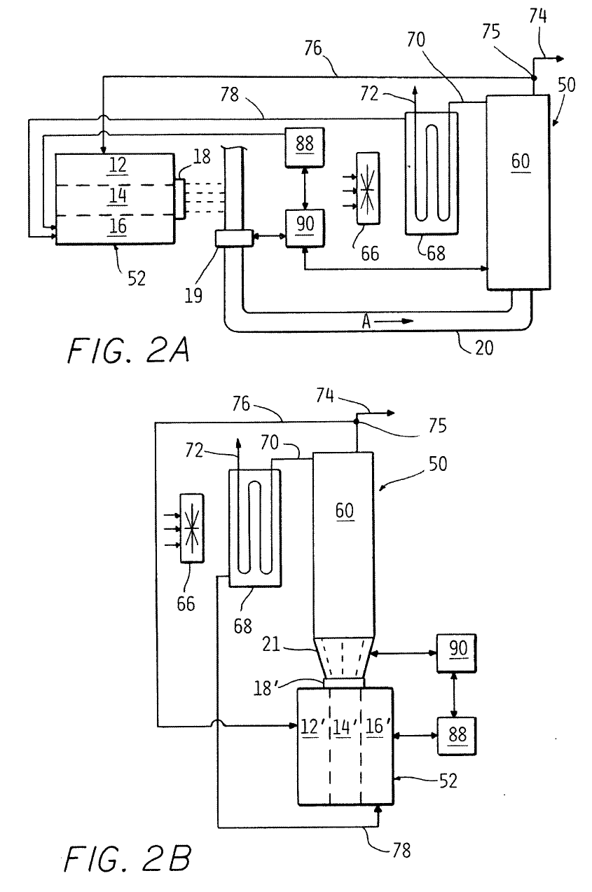

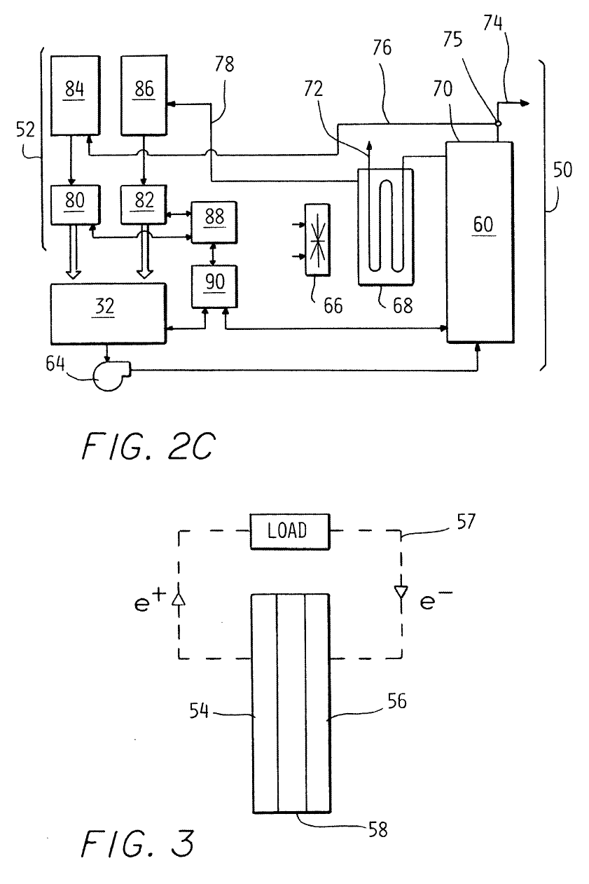

As further illustrated, for example, in FIGS. 2A, 2B, and 2C, the fuel supply device includes electronically controllable drop ejection device 52 adapted to be in communication with an electrochemical cell 50. The drop ejection device 52 can convey quantities of at least one chemical composition capable of oxidative reaction into the electrochemical cell 50.

The drop ejection device 52 may be positioned and configured to convey proportionate amounts of various suitable materials to the electrochemical cell 50 by delivery configurations such as those discussed previously. For illustrative purposes, the delivery configuration discussed in association with FIGS. 1A, 1B, and 1C is illustrated and discussed in greater detail in FIGS. 2A, 2B, and 2C respectively. The electrochemical cell 50 can have a wide variety of applications including batteries, fuel cells, and various other devices for producing electrochemical reactions. The electrochemical cell 50 depicted in FIGS. 2A, 2B, and 2C is typically referred to as a direct methanol fuel cell (DMFC). In such configurations, a material such as methanol is introduced directly into the cell and is oxidized at anode 54 as depicted in FIG. 3. Atmospheric air is supplied to cathode 56 as the oxygen source. Electrons produced travel through the external circuit 57 to the cathode 56 where they are consumed together with oxygen in a reduction reaction. The circuit is maintained within the cell by the conduction of protons in the electrolyte which is based on a suitable proton-conducting polymer electrolyte membrane 58. As depicted in FIGS. 2A, 2B, and 2C, multiple anode/membrane/cathode configurations can be organized into a suitable configuration such as stack 60.

The methanol composition introduced into the electrochemical cell device 50 is a methanol/water mixture capable of undergoing the desired reaction and compatible with the anode, cathode, and polymer membrane materials employed in the cell. As depicted in FIG. 2C, the methanol/water mixture is delivered to a suitable admixer 32 and conveyed to the stack 50. In the embodiment depicted FIG. 2C, conveyance can be accomplished by a suitable mechanism such as pump 64. It is also contemplated that material may be conveyed by passive mechanisms such as devices supporting capillary action or wicking as well as by the mechanism outlined previously in FIG. 1C in which suitable electronically controllable fluid delivery devices 26, 28, 30 are in fluid communication with admixer 32 to convey droplets and/or atomized material to the electrochemical cell 22″. In direct methanol fuel cells, the molar ratio of methanol to water in the conveyed material must be strictly maintained. Excessive concentrations of methanol can disable or compromise the function of the anode/membrane/cathode assembly in general and the polymer electrolyte membrane in particular. Excessive quantities of water compromise the efficiency of the functioning cell.

In the electrochemical cell 50 as depicted in FIGS. 2A, 2B, and 2C the oxygen source is conveyed to the stack 60 by means of a suitable fan 66. Fan 66 can convey air directly to the stack or can convey air through condenser 68 to stack 60. Effluent can be directed away from DMFC stack 60 through conduit 70 into condenser 68. After residence in condenser 68, the air can be exhausted as at conduit 72.

Stack 60 can also include a suitable carbon dioxide exhaust vent and conduit 74 which may have a suitable separator in communication with conduit 76 to convey any unconsumed portions of methanol away from the stack for recycle and reuse as in conduit 76. Separation of methanol and carbon dioxide can occur by any suitable mechanism and means. A methanol separator is denoted at reference numeral 75.

The condenser 68 may also serve to collect and condense water produced at the cathode 56. Water produced by the cathode reaction and condensed in condenser 68 can be conveyed away from condenser 68 by means of conduit 78.

In the device as depicted in FIG. 2A, actuation of a suitable electronically controllable device 52 is governed by a suitable controller 88. As depicted in FIG. 2A, controller 88 is in electronic communication with the electronically controllable jetting device 18 to permit dispensing of one or more of the materials contained in the chambers 12, 14, 16 into contact with a delivery stream passing through conduit 20 in the direction of the flow arrow A.

Materials from one or more of the chambers 12, 14, 16 are dispensed into the stream conveyed through conduit 20 in a manner which provides material of appropriate molar concentration for function of the electrochemical cell or cells in stack 60. Determination of appropriate quantities of the respective materials introduced into the stream conveyed through conduit 20 can be governed by suitable mixing protocols.

The stream conveyed through conduit 20 may be any material suitable for introduction into the electrochemical cell(s) in stack 60. While the construction depicted in FIG. 2A contemplates separate introduction of oxygen, it is understood that the conveyance stream may be a suitable oxygen source to augment or supplement the oxygen source depicted therein.

The materials introduced from the electronically controllable fluid delivery device 52 into the supply stream may be introduced at any point and in any manner that will facilitate material delivery. As depicted in FIG. 2A, the materials are introduced upstream of a mixer 19. Mixer 19 may be any suitable mechanical or structural device which facilitates mixture of the various materials and entrainment in the delivery stream.

It is also contemplated that the device disclosed may include an appropriate sensor element or elements as at reference numeral 90. Sensor 90 as depicted in FIG. 2A is in communication with the conduit 20 as at mixer 19. The sensor 90 can be capable of determining factors important to operation. Examples of such factors can include factors such as flow rate, molar concentration of one or more of the respective materials, etc. The sensor 90 can also be capable of conveying such information to controller 88 to regulate the introduction of additional material(s) to maintain optimum molar concentration. It is also contemplated that this sensor or others can be in communication with stack 60 to determine energy output, consumption demands, etc., as desired or required.

In the device as depicted in FIG. 2B, actuation of a suitable electronically controllable delivery device 52 is governed by a suitable controller 88 in a manner as discussed previously in conjunction with FIG. 2A. In the device as depicted in FIG. 2B, the electronically controllable fluid delivery device 52 is positioned to convey materials from device 18′ into contact with the anode(s) of various electrochemical cells in the stack 60. As depicted in FIG. 2B, the electronically controllable fluid delivery device 52 may deliver materials from a suitable jetting head 18′ into a baffle 21.

Materials from one or more chambers 12′, 14′, 16′ in electronically controllable fluid delivery device 52 can be dispensed into contact with the electrochemical cells in stack 60 in a manner providing a resulting material of appropriate molar concentration for function of the various electrochemical cells. Determination of appropriate quantities of the respective materials can be governed by suitable mixing protocols and carried out or implemented by commands or signals produced by the controller 88.

It is also contemplated that the device depicted in FIG. 2B may also include appropriate sensor elements as at reference numeral 90. Sensor 90 as depicted in FIG. 2B is in communication with baffle 21. The sensor can be configured to ascertain molar concentration of the respective dispensed materials and be capable of conveying such information to controller 88 to regulate introduction of materials to maintain optimum material concentrations. It is also contemplated that the sensor 90 or other suitable sensors can be in communication with stack 60 or elements associated with the stack to ascertain factors such as energy output and consumption demands.

In the device as disclosed in FIG. 2C, electronically controllable drop ejection device 52 includes two fluid delivery devices 80, 82 that convey material to a suitable admixer 32. While the device as disclosed and depicted in FIG. 2C depicts two electronically controllable fluid delivery devices 80, 82, it is to be understood that any number of fluid delivery devices can be utilized. Fluid delivery devices 80, 82 may be configured in any manner suitable to delivery measurable quantities of appropriate materials into admixer 32 as disclosed herein. The fluid delivery devices are electronically controllable drop ejection devices.

As depicted in FIG. 2C, electronically controllable fluid delivery devices 80, 82, are associated with respective storage reservoirs 84, 86. At least one of the reservoirs, 84, 86, contains a chemical composition capable of oxidative reaction. Additional reservoirs can be associated with appropriate electronically controllable fluid delivery devices to meter or convey materials or compositions that maintain, promote, or enhance the reaction occurring in the electrochemical cells found in stack 60. As depicted schematically, it is contemplated that one of the reservoirs, such as reservoir 84, will contain a concentrated composition which includes the compound(s) capable of oxidative reaction, i.e., methanol. Second storage reservoir 86 can be configured to contain diluent materials such as water necessary to provide the molar concentration of methanol in water suitable for function of the cathode/membrane/anode assembly employed in DMFC stack 60.

As depicted in each of FIGS. 2A, 2B, and 2C, water byproducts of the electrochemical reaction can be conveyed through conduit 78 to an appropriate collection point. In FIGS. 2A and 2B water byproducts are conveyed to chamber 16, 16′. In FIG. 2C water byproducts are conveyed to reservoir 86. Unconsumed methanol can be conveyed to through conduit 76 to an appropriate collection point. In FIGS. 2A and 2B unconsumed methanol is conveyed to chamber 12, 12′. In FIG. 2C unconsumed methanol is conveyed to reservoir 84.

The actuation of electronically controllable fluid delivery devices such as device 52 or devices 80, 82 can be governed by controller 88. As depicted in FIG. 2C, controller 88 is in electronic communication with electronically controllable fluid delivery devices 80, 82 to permit dispensing of the associated materials in a manner which provides a material of appropriate molar concentration for function of the electrochemical cell or cells in stack 60. Determination of the quantities of the respective materials introduced into admixer 32 can be governed by suitable mixing protocols. As depicted in FIGS. 2A and 2B, controller 88 can govern actuation of electronically controllable fluid delivery device 52 to permit dispensing of material from the various chambers to provide a material with components in a desired concentration.

As depicted in FIGS. 2A, 2B, and 2C, sensor 90 can communicate with various elements of the device disclosed herein such as admixer 32. The sensor 90 can be capable of ascertaining various relevant physical and/or chemical characteristics such as the molar concentration of respective materials introduced and conveying such information to controller 88 to regulate the introduction of additional material or materials to maintain optimum molar concentration within the delivery stream or various locations such as admixer 32. It is also contemplated that this or other sensors can be in communication with stack 60 to determine relevant information, for example energy output and consumption demands. Information relating to energy output and/or consumption demands can correlate to quantities of additional material necessary to be introduced as into admixer 32 or feed stream in order to maintain appropriate molar concentration of the feed material.

While the device depicted in FIGS. 2A, 2B, and 2C contemplates direct introduction process stream introduction or introduction into a suitable admixer, it is contemplated that additional holding tanks and/or electronically controllable fluid delivery devices could be integrated at various locations prior to entry of the material into the stack 60 as desired or required. Thus, by way of non-limiting example, additional compounds or compositions may be introduced into the feed material after exit from admixer 32 as by a suitable fluid delivery device.

The device as depicted in the various views of FIGS. 1 and 2 can also be configured to deliver materials in addition to the oxidizable material or fuel such as methanol and a diluent such as water. Thus additional chambers such as chamber 14, 14′ or delivery devices such as electronically controllable fluid delivery device 28 can contain various additives, cleansing agents, etc.

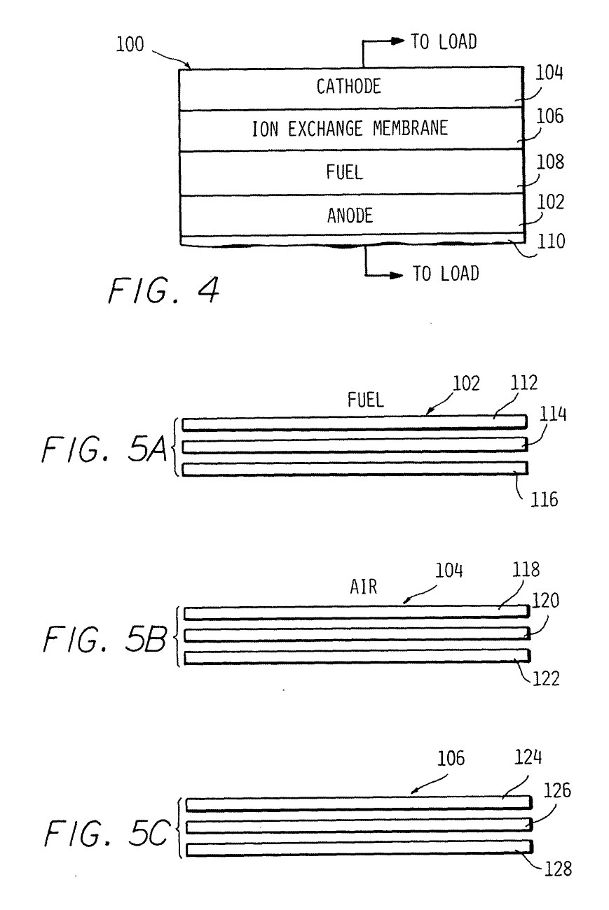

As illustrated, for example, in FIG. 4, an alternate electrochemical cell 100 in accordance with an embodiment of the present invention includes an anode 102 (or “fuel electrode”) and a cathode 104 (or “air electrode”). An optional ion exchange membrane 106 which is secured to the cathode in the exemplary embodiment, may be provided in those instances where a soluble chemical composition 108 is used.

As disclosed herein, the chemical composition(s) delivered is one which is either present as a fluid or is fluidizable. The material of choice may be a single chemical component or a multi-component composition. The chemical composition 108 depicted in FIG. 4 is one capable of oxidative reaction. Such materials can be referred to as “fuels.” However, it is to be understood that this term is used in a non-limitative sense. Chemical composition 108 may be any material capable of oxidative reaction. The material can be made up of various components individually stored and introduced into contact with the cell.

The chemical composition 108 or fuel is consumed at the anode 102. An oxidant is consumed at the cathode 104. The oxidant may be any material which is capable of reacting with the chemical composition 108 to produce an oxidative reaction. Typically, the material may be oxygen which is derived from any source such an ambient air.

As depicted in FIG. 4, the anode 102 may be protected from the air by an air impermeable membrane 110. The chemical composition 108 is delivered to and located within a relatively thin space (i.e., about 0.5 mm to about 5 mm) between the anode 102 and the ion exchange member 106. The manner in which the chemical composition is situated adjacent to the anode 102 will depend on the use to which the electrochemical cell is put and particulars of the configuration of the given electrochemical cell. For example, a space for additional material may be provided between the anode 102 and the air impermeable membrane 110.

As indicated previously, the chemical composition 108 or fuel may be any suitable material capable of undergoing an oxidative reaction which can occur at the anode 102 of the electrochemical cell 100. The specific makeup of the chemical composition present in the electrochemical cell may encompass one or more chemical components that individually or collectively achieve this end. Additionally, the chemical composition present in the electrochemical cell typically includes suitable diluents that will facilitate the effective use of the electrochemical cell.

In the electrochemical system, the exemplary anode 102 can be composed of any suitable material which will facilitate the oxidative reaction. For example, the anode 102 can be composed of a suitable stainless steel material as well as other oxidative supporting materials. As illustrated as an example in FIG. 5A, the exemplary anode 102 may be a membrane electrode assembly (MEA) that consists of a support layer 112, a catalyst layer 114 and a stainless steel collector 116. The support layer 112 may be composed of any suitable polymeric material. The catalyst layer 114 may be any suitable transition metal or transition metal alloy. The collector 116 is preferably a porous structure such as a porous plate or mesh formed from suitable microfibers or a suitable composite. Where stainless steel is employed, the microfibers and/or composite can be a suitable stainless steel. Various grades of stainless steel can be employed successfully as the anode material in an electrochemical cell employed in the present invention. A non-limiting example of one such material is 316 stainless steel.

It is to be understood that other anode materials can be successfully employed in the electrochemical cell of the present invention. Other suitable materials are typically those that will not catalyze the chemical composition or fuel to hydrogen but will catalyze the electrolytic reaction occurring at anode 102.

The exemplary cathode 104 can be composed of a transition metal or transition metal oxide. As illustrated in the example in FIG. 5B, the exemplary cathode 104 is configured in the form of an MEA. More specifically, the exemplary cathode 104 consists of an air permeable, liquid impermeable membrane layer 118, a catalyst layer 120 formed of a transition metal or transition metal oxide and a collector 122 formed of a metal mesh such as stainless steel, copper or gold-plated nickel mesh. Examples of transition metal materials which can be employed as either the transition metal or transition metal oxide include at least one of scandium, titanium, vanadium, chromium, manganese, iron, cobalt, nickel, copper, zinc, yttrium, zirconium, niobium, molybdenum, technetium, ruthenium, rhodium, palladium, silver, cadnium, hafnium, tantalum, tungsten, rhenium, osmium, iridium, platinum, gold, mercury, rutherfordium, dubnium, seaborgium, bohrium, hassium, meitnerium, ununnilium, unununium, and ununbium.

One example of the optional ion exchange membrane 106 is illustrated in FIG. 5C, the exemplary ion exchange membrane includes a support layer 124 such as a metal or plastic mesh, an electrolyte 126 and a membrane 128.

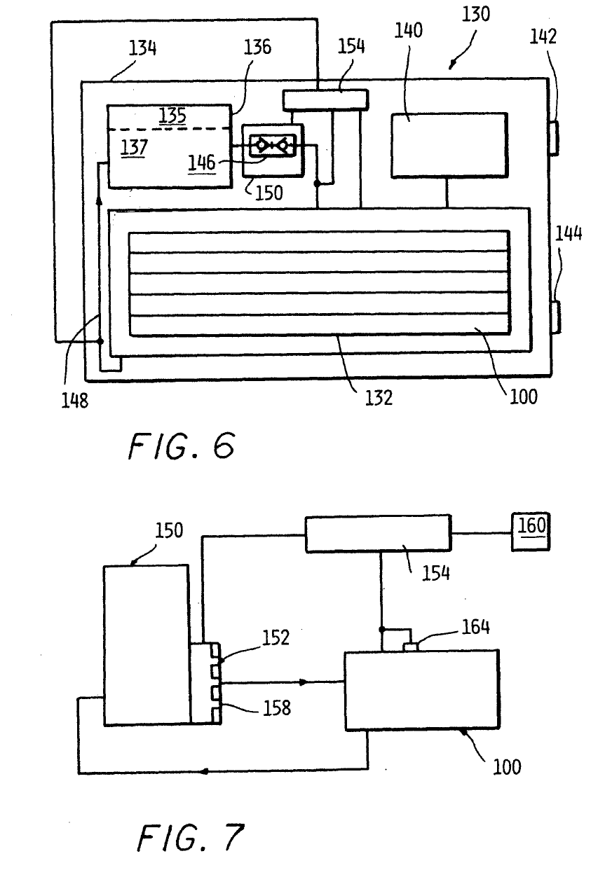

The electrochemical cell 100 of the device as disclosed has a wide variety of applications including batteries, fuel cells, and various other devices for producing electrochemical reactions. As illustrated by example in FIG. 6, a fuel cell system 130 in accordance with at least one embodiment of the present invention includes a stack 132 with one or more electrochemical cells 100 connected in series located within a housing 134. The chemical composition from a reservoir such as reservoir 136 is supplied to the anodes of the electrochemical cells by way of a suitable manifold arrangement. Air may be supplied to the stack 132 by drawing air through a vent (not shown) that is formed in the housing 134. An optional fan 140 may be provided either in the housing 134 or within an associated host device for this purpose. The exemplary fuel cell system 130 can also be provided with a pair of contacts that are respectively connected to the anode series and cathode series. Exemplary materials for the contacts 142 and 144 include copper or gold-plated nickel electrode mesh.

As shown in FIG. 6, the reservoir 136 functions as a fluid storage chamber for containing the composition capable of oxidative reaction. The fluid storage chamber or reservoir 136 can be in the form of a removable cartridge that mates with a connector 146 when the cartridge is inserted in the housing 134. Alternately, the reservoir may be fixed in place and refilled as necessary. The electrochemical cell 100 has at least one exit outlet (not shown) which facilitates the egress of at least one byproduct of the oxidative reaction occurring in the electrochemical cell. The outlet is fluid communication with a suitable conduit 148 which itself communicates with the fluid storage reservoir 136. The outlet may be configured with a suitable manifold (not shown) that facilitates the separation of at least a portion of the desired by-product and routes it into the fluid conduit 148. In this manner, a portion of at least one byproduct material can be reintroduced into the fluid storage chamber 136 for reintegration into the chemical composition to be introduced into the electrochemical cell 100.

The reservoir 136 includes chambers 135, 137 that permit storage of a suitable compound capable of oxidative reaction such as a fuel as in chamber 135 and a suitable diluent as in chamber 137. The device disclosed also includes a suitable fluid delivery device or devices for introducing material into the electrochemical cell. The fluid delivery device can be a suitable electronically controllable drop ejection device. As shown in FIG. 6, the electronically controllable ejection device 150 is in association with the electrochemical cell 100 in a manner that facilitates delivery of the material composition to the appropriate location on the cell 100. The drop ejection device 150 is capable of conveying suitable quantities of chemical composition capable of oxidative reaction in suitable concentration from the fluid storage reservoir 136 into the electrochemical cell 100 in a manner which promotes and facilitates the oxidative reaction occurring therein. As schematically depicted in FIG. 6, the drop ejection device 150 is integrated with the coupling connector 146. The drop ejection device 150 may be either upstream of the coupling connector 146; i.e., between the fluid storage reservoir 136 and coupling connector 146; or downstream of the coupling connector 146; i.e., between coupling connector 146 and a suitable manifold (not shown). The location of the drop ejection device 150 will depend, at least in part, upon the design requirements of the specific device 130, fluid storage chamber 136, and the electrochemical cell 100.

The electronically controllable drop ejection device 150 is one which provides a measured quantity of the chemical composition to be introduced. The electronically controllable drop ejection device 150 is generally configured and functions in a manner similar to an inkjet device. The drop ejection device 150 includes at least one electronically controllable nozzle member 152 which permits the egress of measured quantities of material contained in an associated fluid storage reservoir 136. Typically, the chemical composition capable of oxidative reaction contained in chamber 135 and/or other material(s) contained in a fluid storage reservoir such as in chamber 137 exits the nozzle member 152 in the form of ejected droplets.

In the various embodiments of the device disclosed herein one or more of the electronically controllable fluid delivery devices may be a suitable electronically controllable drop ejection device as discussed in relation to FIG. 6. Examples of suitable drop ejection devices that may be used in the various embodiments can include thermal drop ejection devices or piezoelectric drop ejection devices depending upon the design parameters and requirements implemented. It is also considered within the purview of this invention that the drop ejection device may be configured as a hybrid of the two aforementioned drop ejection devices or may be of some other configuration which permits the electronically controllable introduction of at least one chemical composition into the associated electrochemical cell.

As depicted in FIG. 6, electronic control may be exerted by a suitable controller 154 adapted to receive electronic input and transmit suitable control signals actionable on the drop ejection device 150. The fluid storage reservoir 136 can be configured to have at least two chambers 135 and 137 configured and adapted to hold different components necessary or desirable for promoting the oxidative reaction of the chemical composition in the electrochemical cell 100. Thus, in a simple configuration, the fluid storage reservoir 136 has at least two chambers in which chamber 135 may contain the chemical composition capable of oxidative reaction while the chamber 137 is adapted to contain a diluent, additive or other material which can be effectively added or integrated with the chemical composition for supporting or promoting the oxidative reaction.

As depicted in FIG. 6, chamber 137 is in fluid communication with an outlet (not shown) located in the electrochemical cell 100 by means of a channel or conduit 148. The channel or conduit 148 is configured to remove at least a portion of a byproduct of the oxidative reaction in a manner that will permit the conveyance of the removed byproduct into subsequent contact with the anode 102 in a manner which promotes or facilitates the oxidative reaction occurring in the electrochemical cell 100. Chamber 137 is configured and adapted to accumulate the useful byproduct of oxidative reaction for subsequent dispatch back into the electrochemical cell 100. The channel or conduit 148 and associated chamber 137 is in communication with the drop ejection device 150 to permit proportionate delivery of the useful byproduct of oxidative reaction and the chemical composition capable of oxidative reaction into contact with the electrochemical cell 100. It is envisioned that the useful byproduct is delivered to the electrochemical cell 100 in a stoichiometric quantity relative to the chemical composition and appropriate for introduction into the electrochemical cell 100.

By “stoichiometric quantity,” it is meant that the material is present in a ratio suitable to facilitate reaction progress in the electrochemical cell. As used herein, “proportionate delivery” is employed to refer to a ratio or ratios of chemical composition and byproduct suitable for appropriate function of the associated electrochemical cell 100. Thus, by way of non-limiting example, it is envisioned that water produced as a byproduct of the oxidative reaction can be conveyed away from the electrochemical cell 100 through conduit 148. A portion of the water byproduct can be reintegrated with concentrated amounts of the chemical composition capable of oxidative reaction held in a suitable reservoir such as chamber 135.

In many fuel cell configurations, the nature and structure of the MEA requires that the concentration of the fuel material or, more broadly stated, the composition capable of oxidative reaction must be strictly limited to ensure the continued function of the membrane material. This necessitates the storage of fuel material in dilute concentrations appropriate for function of the MEA with associated adaptations made in storage chambers for the volume and weight of dilute fuel material. The device disclosed in the various embodiments permits the proportionate delivery of multiple components into an electrochemical cell according to at least one control parameter or algorithm determined by criteria which include, but are not limited to, the nature of the fuel, composition or nature of additives, diluents and the like, the nature of the electrochemical cell to which the fuel is delivered, and external operating demands or conditions. Proportionate delivery of a chemical composition and at least one associated additive or diluent by means of suitable electronically controllable fluid delivery device(s) such as at least one drop ejection device accomplishes precise titration of the various components to promote the advantageous function of the electrochemical cell. Advantageous function can include, but is not limited to, promotion of efficiency of the electrochemical cell, maintenance of catalysis within the electrochemical cell, and prolonged life and function of the electrochemical cell.

While the device as depicted in FIG. 6 shows a reservoir 136 having two chambers 135 and 137, as indicated in previous embodiments, it is contemplated that the device can include multiple delivery devices having multiple chambers. Additionally, it is contemplated that the various delivery devices can hold the chemical composition capable of oxidative reaction or fuel as well as various diluents, additives, enhancers, or the like. It is also contemplated that the chemical composition capable of oxidative reaction or fuel may be composed of a chemical compound or various chemical compounds in admixture. To this end, the chemical composition may be held in and delivered from a single fluid delivery device or chamber, or the various components may be held in separate devices or chambers until proportionate delivery into contact with the electrochemical cell in a manner appropriate for efficient function of the cell.

By way of example, proportionate delivery of the product or products can be accomplished by a drop ejection device such as an electronically controllable drop ejector 150. It is also contemplated that proportionate delivery may be accomplished by a suitable manifold associated with the compartments or reservoirs for permitting appropriate proportionate mixture of one or more of the various components. As depicted schematically in FIG. 7, the drop ejection device 150 includes a nozzle member having a nozzle plate and a plurality of nozzles or other orifices 158 formed therein. The nozzles 158 are preferably sized and configured to permit the ejection of a spray of droplets from the drop ejection device 150. The drop ejection device 150 and associated nozzles 158 are electronically controlled by a suitable controller 154 and may be of any suitable configuration which will permit the egress of proportionate measured portions of the material conveyed therethrough. Such drop ejection devices include, but are not limited to, devices having mechanical and electronic architecture as would be generally found in thermal inkjet devices and piezoelectric devices.

It is contemplated that the controller 154 is in electronic communication with the electrochemical cell 100 and may be in communication with any suitable external interface 160. In this manner, controller 154 can execute commands actionable on nozzle member 152 to control the ejection of one or more of the materials contained in the various reservoirs. It is contemplated that the controller 154 may contain suitable algorithms for calculating proportions of various materials to be delivered to the electrochemical cell.

External interface 160 may include suitable sensors or monitoring devices which assess conditions external to the electrochemical cell 100 and associated devices. External interface 160 may include electronics which permit monitoring and/or adjustment of the function of the drop ejection device 150 and associated fuel cell 100 as desired or required.

It is also contemplated that the device may include at least one sensor 164 capable of detecting at least one product of the oxidative reaction occurring in the electrochemical cell 100. Depending upon the requirements of the particular system, it is contemplated that the sensor 164 can include devices and/or configurations which permit the ascertainment and/or analysis of at least one component of the oxidative reaction. This component may be a chemical byproduct or may be a desired output product depending upon the mechanism and electrochemical reaction occurring within the electrochemical cell 100. As desired or required, additional sensors may be positioned in the electrochemical cell for monitoring the process and providing iterative information regarding the introduction of additional fuel or the like.

As discussed previously in conjunction with the embodiments depicted in FIGS. 1 and 2, electronically controllable nozzle member 152 of the drop ejection device 150 can be configured with an orifice 158 to direct material(s) such as the chemical composition capable of oxidative reaction as well as any optional additives and the like may be conveyed directly onto the anode 102 of the electrochemical cell or may be introduced into a carrier stream which is conveyed onto the anode 102. The fluid stream may be composed of a suitable liquid diluent(s), gas(es), or the like, capable of conveying the material into the desired location. As depicted in FIG. 8, the nozzle member 152 can be configured and positioned to direct material into contact with a fluid stream conveyed through conduit 166 by pump 162 to direct material into contact with the anode 102. It is also contemplated that the nozzle member 152 can be configured and positioned to convey material into a fluid stream downstream of a suitable pump where desired or required.

While the foregoing has been described utilizing one drop ejection device 150, multiple devices in fluid communication with associated chemical compositions to be employed in the oxidative reaction occurring in electrochemical cell can be employed. In such situations, it is contemplated that a first or primary chemical composition which will undergo a desired oxidative reaction may be administered by a suitable drop ejection device. Additional chemical composition(s) or compound(s) appropriate for admixture with the first chemical composition in a manner which facilitates or advances the oxidative reaction which progresses in the electrochemical cell may be administered by additional drop ejection devices. Such additional chemical compositions or compounds can include materials which enhance the chemical reaction occurring in the electrochemical cell. Alternately, the additional chemicals or compounds can include materials and compositions which can initiate, enhance or promote reformation of one or more materials utilized for oxidation. It is also contemplated that a suitable material or composition may be one that can clean or refurbish surfaces or components of the electrochemical cell.

Where multiple materials are employed, it is contemplated that the materials are delivered to the anode in a manner that accomplishes admixture of the various compositions or compounds to facilitate the oxidative reaction occurring therein. Thus, the various materials can be admixed upon exit from the respective nozzle members and conveyed directly into contact with the anode. The materials may also be conveyed as an atomized material in a gaseous stream or can be delivered into a liquid process stream which itself is conveyed to the anode 102 as depicted in FIG. 8. As desired or required, an additional device, such as pump 162, can be employed to facilitate delivery of the materials to the anode 102.

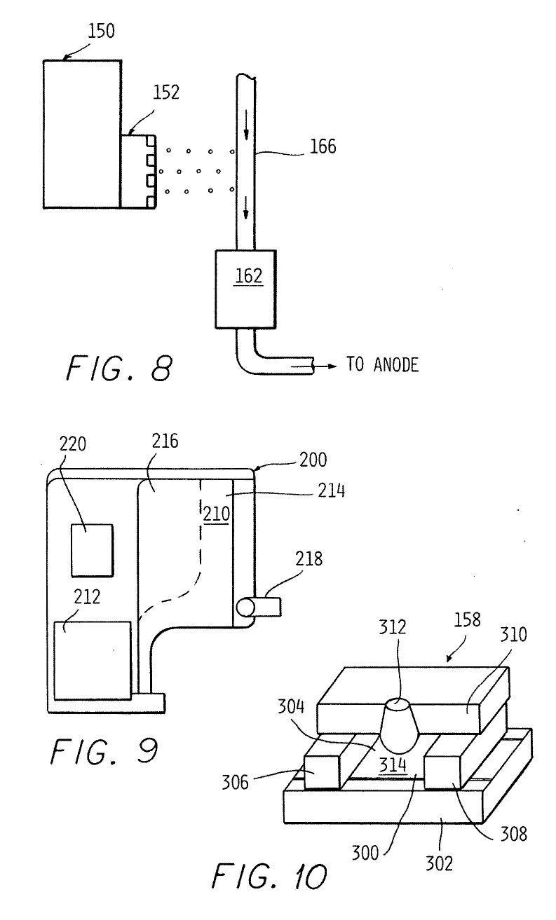

As shown in FIG. 9, cartridge 200 has a storage chamber 210 containing a volume of at least one chemical composition to be utilized by an electrochemical cell. The chemical composition contained in the storage chamber 210 typically comprises at least one compound capable of an oxidative reaction upon contact with an anode 102 of a suitably configured electrochemical cell. The cartridge 200 further includes a drop ejection device 212 capable of dispensing measured quantities of the chemical composition from the storage chamber into an associated electrochemical cell. The storage chamber 210 of cartridge 200 can comprise multiple compartments 214, 216 that can each contain at least one compound suitable for introduction into an electrochemical cell.

The cartridge 200 can be configured such that a compartment, such as compartment 214 for example, is configured to accumulate a useful byproduct of the oxidative reaction occurring in the electrochemical cell for subsequent reintegration and dispatch through the associated drop ejection device 212. As depicted in FIG. 9, this can include, but is not limited to, suitable fluidic couplings, such as coupling 218, which permit communication with a suitable conduit conveying byproduct(s) away from the associated electrochemical cell. The drop ejection device 212 associated with cartridge 200 may be any suitable device capable of producing measured quantities of the desired chemical composition(s) and facilitating ultimate introduction of the emitted material(s) into contact with the anode surface of an electrochemical cell in a manner which facilitates the oxidative reaction occurring at the anode surface. Thus, the drop ejection device may be configured and function in a manner similar to a suitable thermal inkjet device, a suitable piezoelectric ink-jet device, or other appropriate configurations which would permit and facilitate the dispensing of the quantities of chemical composition desired and appropriate.

The cartridge 200 of the present inventions may also include at least one control device 220 in electronic communication with the drop ejection device(s) 212. The control device 220 may contain at least one logic sequence governing the actuation of the drop ejection device. The control device may include logic and information permitting an interactive link to be established with at least one device external to the cartridge 200. It is contemplated that the control device 220 will include logic necessary for the actuation and appropriate function of the associated drop ejection device(s) 212 as well as appropriate integration into the associated electrochemical system or the like. It is also contemplated that the control 220 can include suitable electronic chips or the like which can contain data relevant to the material contained in the storage chamber or chambers. Such data can include, but is not limited to, data regarding the contents of the storage chamber including chemical composition, expiration date and the like, as well as information regarding material cycling through the storage device as appropriate. The memory chip may include at least one protocol interactive with data received from an external source such as, but not limited to, user interface modules, sensors and the like. The protocol contained in the chip is one which would typically produce at least one command actionable on the drop ejection device(s) 212.

The drop ejection device 212 employed in cartridge 200 as well as drop ejection devices 10, 10′, 52, and in embodiments such as those depicted in FIGS. 1, 2, 6, and 7 may have any suitable configuration as would typically be found in a thermal inkjet device or a piezoelectric jetting device. The drop ejection device 212 will typically include at least one electronically controlled nozzle member (not shown) in fluid communication with an associated sub-chamber 214, 216 and a control mechanism associated with the nozzle member which can control the ejection of a measured quantity of the chemical composition from the storage chamber.

Where desired, the nozzle member 158 of the drop ejector can include at least one resistor 300. As depicted as part of the exemplary nozzle in FIG. 10, a suitable resistor 300 is positioned on substrate 302 in a chamber 304. The chamber 304 is defined by suitable barriers 306, 308 and orifice plate 310 to form a region into which the desired material can collect. Material introduced into chamber 304 can be ejected through orifice 312.

As shown in FIG. 10, the resistor 300 can be formed of suitable material. The resistor 300 can be an electrically driven thin film resistor of a type generally found in thermal ink jet devices. The resistor 300 can be configured to have at least one surface which is reactive with at least one component of the composition capable of oxidative reaction. As used herein, the term “reactive” is taken to mean that the resistor surface is capable of triggering at least a partial chemical reaction with at least one component present in the composition passing through the nozzle member 158. The partial or complete reaction is one that can result in the partial or complete catalytic reformation of at least one chemical compound present in the composition. The resulting catalyzed compound may be one more readily oxidized as a result of the processes occurring subsequently in the associated electrochemical cell. Alternately, reactions that occur on or are promoted by the resistor 300 can result in a compound(s) synergistically advantageous to the oxidative reaction occurring in the electrochemical cell. For instance, the resulting compound may be one that renders the associated composition more reactive, provides a more favorable byproduct panel or the like. As indicated, reactivity is not limited to complete reformation of the chemical composition or an individual compound(s). Partial reactivity or reformation is also contemplated. Thus, the surface of the resistor 300 may be one which initiates a reformation or catalysis which more advantageously progresses in the electrochemical cell.

It is contemplated that the resistor surface may be reactive with a material considered additive to the primary compound or composition. Thus, it is possible to provide additives and enhancements as well as fuel materials containing components that may be more transitory or lack the shelf stability necessary for storage in a reservoir and inclusion in a fuel system.

Typically, the reactive surface of the resistor 300 will have at least one catalytic material 314 imparted thereon. The catalytic material 314 will be one which is capable of supporting at least partial catalytic reformation of the target component in the material introduced into the chamber 304.

It is also contemplated that the resistor surface may be configured with a material which will enhance cleaning or regeneration of the resistor 300 surface after continued or prolonged use. In this scenario, it is contemplated that an associated storage reservoir may include a compartment which is configured to include a cleansing aid which is catalytically reactive upon contact with the resistor to remove residues or the like which may be impairing resistor function.

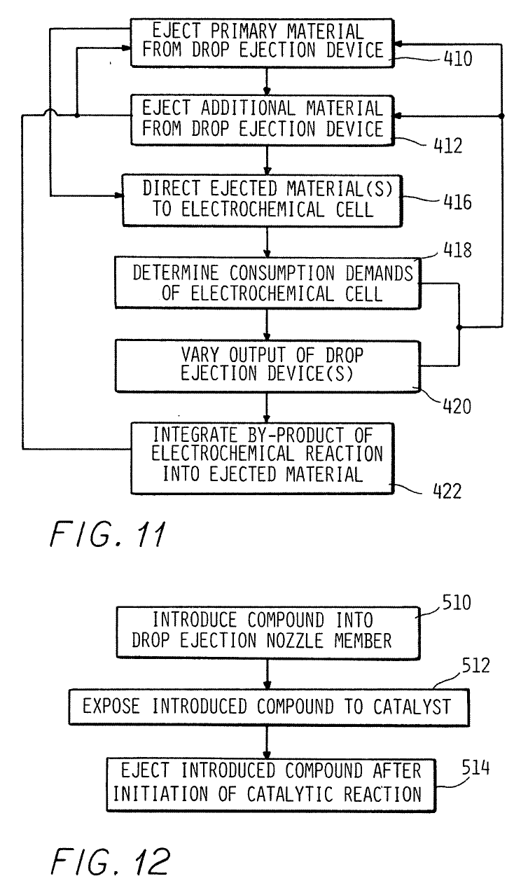

A method of delivering material to an electrochemical cell 100 is outlined in FIG. 11. The method contemplates ejection of primary material from a drop ejection device 410. The drop ejection device employed is electronically controllable and is capable of ejecting a quantity of material determined by at least one of consumption demands of the electrochemical cell, composition of the material ejected, composition and/or quantity of additional materials introduced into the electrochemical cell contemporaneous with the ejection of the primary material.

The primary material is generally considered to be a compound or composition capable of undergoing oxidative reaction in an electrochemical cell. Such materials are generally referred to as fuels.

The method also contemplates the ejection of additional materials from drop ejection device(s) 412. The additional materials can include, but are not limited to, additives, diluents and the like. The additional materials can be ejected contemporaneous with ejection of the primary material. By “contemporaneous,” it is meant that the additional material is ejected in a manner and at a time interval that promotes or contributes to the oxidative reaction occurring in the electrochemical cell.

The ejected material(s) are directed to the electrochemical cell at 416. It is contemplated that the material(s) may be injected directly into contact with the electrochemical cell or may be introduced into a carrier stream or device that ultimately directs the ejected material(s) into contact with the electrochemical cell.

Various events and parameters can be utilized to vary the ejection actions of the drop ejection device(s) at 420. These can include, but are not limited to, determination of consumption demands of the electrochemical cell 418. It is contemplated that detection of such an event or parameter can be translated to a suitable signal which can be detected by a controller which acts upon the drop ejection device(s) to provide proportionate delivery of the material(s) which can vary based upon demands and function of the electrochemical device.

It is also contemplated that at least one byproduct of the electrochemical reaction occurring in the electrochemical cell can be reintegrated into the primary material at 422. Reintegration can occur either prior to ejection of the primary material from the drop ejection device or subsequent to such ejection. It is contemplated that the byproduct material can be introduced to a suitable associated drop ejection device for proportionate re-integration with the ejected material.

The byproduct material may also be proportionately integrated with additional material(s) either before or after ejection of the additional material(s) complimentary with the primary material or fuel in a manner which permits proportionate delivery of the materials into the electrochemical cell.

The method can also include the step of partially reforming at least one component (i.e. target component) present in at least one of the primary material and the additional material to a compound that facilitates or promotes the oxidative reaction occurring in the electrochemical cell. Partial reformation is initiated by contact with a resistor present in the drop ejection device. The resistor includes at least one material that catalyzes partial reformation.

A partial reformation of the target component can be initiated at the catalytic surface. It is contemplated that the partial reformation reaction can be accomplished at the reactive surface. It is also contemplated that contact with the resistor can initiate a partial reformation process or reaction which continues after ejection of the material from the drop ejection device.

With reference to FIG. 12, a method for initiating reaction of chemical composition or compound is outlined in which the chemical compound is introduced into a chamber of a drop ejection nozzle member 510. The chemical compound is exposed or brought into contact with a catalyst located in the fluid chamber in a manner or under circumstances that initiate a catalytic reaction 512. The chemical compound is ejected from the fluid chamber after initiation of the catalytic reaction 514.

The catalytic reaction may occur within the confines of the fluid chamber. It is also contemplated that partial reaction may occur within such confines. The progress of the reaction is generally that sufficient to initiate a catalytic reaction process. The resulting catalytically reacted product can be one in which a portion of the material or compound contained in the fluid chamber is reformed. The extent of catalytic reaction which occurs is generally that required for the given end use destination or application of the reformed material. The reaction catalyzed in the fluid chamber may proceed for an interval subsequent to ejection. The reaction may also be initiated to proceed or begin a multi-step chemical process as desired or required.

A non-limiting example of a reaction that can occur in the fluid chamber of the ejection device is the partial or complete catalytic reformation of a chemical compound capable of undergoing oxidative reaction in an electrochemical cell. Other reactions that can be initiated and accomplished may include various other single and multi-component catalyzed chemical reactions.

It can be appreciated from the foregoing discussion that the method and associated device permits and facilitates reactions on a microfluidic scale. Such catalytic capacity can enable study of material reactions and products on a level more closely reaching molecular levels. Additionally, the method and device permit the production and more effective use of transient reaction intermediates that can be delivered to various end use applications. Such end use applications include, but are not limited to, delivery and analytical devices or supplemental chemical compounds or reaction vessels in addition to the delivery of such materials to electrochemical cells.

It is contemplated that the method and device can be used with an appropriate power generator which can be integrated into or employed with a suitable power consuming device such as a portable telephone, notebook computer, or the like.

Although the present inventions have been described in terms of preferred embodiments, numerous modifications and/or additions to the above-described preferred embodiments would be readily apparent to one skilled in the art. It is intended that the scope of the present inventions extend to all such modifications and/or additions.

1. A device comprising:
an electronically controllable drop ejection device in fluid communication with an electrochemical cell, the drop ejection device capable of conveying quantities of a chemical composition capable of oxidative reaction into the electrochemical cell.

2. The device of claim 1 further comprising:
a fluid storage chamber containing the chemical composition capable of oxidative reaction, the fluid storage chamber in communication with the drop ejection device; and
an electrochemical cell having an inlet and an outlet and anode, the electrochemical cell supporting oxidative reaction of the chemical composition.

3. The device of claim 1 further comprising a channel for removing a byproduct of the oxidative reaction from the electrochemical cell, the channel communicating with the electronically controllable drop ejection device, wherein the electronically controllable drop ejection device introduces the reaction byproduct into contact with the chemical composition capable of oxidative reaction in a stoichiometric relationship appropriate for function of the electrochemical cell.

4. The device of claim 3 wherein the drop ejection device is configured to affect proportionate delivery of the byproduct of oxidative reaction and the chemical composition capable of oxidative reaction into contact with the electrochemical cell.

5. The device of claim 1 further comprising at least one external interface device, the external interface device receiving at least one input command from a source external to the device, the input command actionable on the drop on demand ejection device.

6. The device of claim 1 further comprising an admixer in fluid communication with the drop ejection device, the admixer tank configured to receive the chemical composition capable of oxidative reaction and at least one other additional material.

7. The device of claim 6 wherein the drop ejection device includes at least one electronically controllable nozzle member.

8. The device of claim 7 wherein the nozzle member directs ejection of chemical composition capable of oxidative reaction into a fluid stream, the fluid stream being conveyed onto the anode of the electrochemical cell.

9. The device of claim 7 wherein the nozzle member directs the chemical composition into the admixer, the fluid stream conveyed from the admixer into contact with the anode.

10. The device of claim 1 wherein a first electronically controllable drop ejection device is in fluid communication with a first composition capable of oxidative reaction and a second electronically controllable drop ejection device is in fluid communication with at least one second composition capable of admixture with the first chemical composition in a manner which facilitates the oxidative reaction.

11. The device of claim 10 wherein the compositions are delivered to the anode in a manner that accomplishes admixture.

12. The device of claim 10 further comprising an admixer in fluid communication with the drop ejection devices, the admixer configured to receive the materials and convey admixed materials to the electrochemical cell.

13. The device of claim 10 further comprising a channel for removing at least one reaction byproduct from the electrochemical cell, the channel communicating with the second electronically controllable drop ejection device, wherein the second electronically controllable drop ejection device introduces the reaction byproduct into contact with the chemical composition capable of oxidative reaction in a stoichiometric relationship appropriate for function of the electrochemical cell.

14. The device of claim 1 wherein the electronically controllable drop ejection device comprises a resistor surface having at least one catalytic material positioned thereon, the catalytic material reactive with a component in the chemical composition capable of oxidative reaction to effect at least partial catalytic reforming of the component of the chemical composition.

15. The device of claim 14 wherein catalytic reforming occurs prior to exit from the drop ejection device.

16. The device of claim 1 wherein the drop ejection device further comprises a resistor, the resistor having a surface reactive with a component of the chemical composition capable of oxidative reaction.

17. The device of claim 16 wherein the resistor comprises at least one catalytic material, the catalytic material capable of supporting at least partial catalytic reformation of at least one component of the composition capable of oxidative reaction.

18. The device of claim 10 wherein the drop ejection device further comprises a resistor, the resistor having a surface which is reactive with a component of the second chemical composition.

19. A cartridge for use with an electrochemical cell comprising:
a reservoir containing a volume of a chemical composition containing at least one compound capable of oxidative reaction;
an electronically controllable drop ejection device in communication with the reservoir, the drop ejection device capable of dispensing measured quantities of the associated chemical composition from the reservoir into a suitable electrochemical cell.

20. The cartridge of claim 19 wherein the reservoir is composed of at least two chambers, each chamber containing a compound suitable for introduction into the electrochemical cell.

21. The cartridge of claim 20 wherein a chamber is configured to accumulate a useful byproduct of oxidative reaction produced in the electrochemical cell for subsequent reintegration dispatch through the drop ejection device.

22. The cartridge of claim 19 wherein the drop ejection device includes:
an electronically controllable nozzle member in communication with a reservoir containing a volume of chemical composition containing at least one compound capable of oxidative reaction;
a control mechanism associated with the nozzle member, the mechanism controlling the ejection of a measured quantity of the chemical composition from the storage chamber.

23. The cartridge of claim 19 comprising:
a first chamber containing at least one compound capable of oxidative reaction; and
at least one second chamber containing at least one material compatible with the compound capable of oxidative reaction.

24. The cartridge of claim 23 wherein the material compatible with the compound capable of oxidative reaction includes at least one of additives, diluents and the like.

25. The cartridge of claim 19 wherein the electronically controllable drop ejection device comprises at least one resistor, the resistor having a surface which is reactive with at least one component of the chemical composition containing at least one compound capable of oxidative reaction.

26. The cartridge of claim 19 wherein the electronically controllable drop ejection device comprises a resistor having a surface, the resistor surface reactive with at least one material compatible with the compound capable of oxidative reaction.

27. An electrochemical system comprising:
an electrochemical cell capable of sustaining at least one oxidation reaction process; and
a fuel supply apparatus delivering a composition containing at least one compound capable of oxidative reaction into the electrochemical cell, the fuel supply apparatus comprising at least one electronically controllable drop ejection device and at least one fluid storage chamber.

28. The electrochemical system of claim 27 wherein the electrochemical cell comprises an anode and the fuel supply apparatus introduces a quantity of the composition into contact with the anode.

29. The electrochemical system of claim 28 wherein the electronically controllable drop ejection device comprises an electronically controlled nozzle member in fluid communication with the fluid storage chamber.

30. The electrochemical system of claim 29 wherein the fuel supply apparatus comprises at least two fluid storage chambers, the fluid storage chambers containing materials utilized in the oxidative reaction process occurring in the electrochemical cell.

31. The electrochemical system of claim 27 wherein the composition containing at least one chemical component capable of undergoing oxidative reaction is contained in a first fluid storage chamber and wherein a second fluid storage chamber contains at least one compound which is complementary to the oxidative process occurring in the electrochemical cell.

32. The electrochemical system of claim 31 wherein the fuel supply apparatus further comprises at least one compartment configured to transferably receive at least one byproduct of the oxidative reaction occurring in the electrochemical cell.

33. The electrochemical system of claim 29 wherein electrochemical cell includes a channel for removing at least one reaction byproduct, the channel conveying the reaction byproduct into communication with the electronically controllable drop ejection device, wherein the electronically controllable drop ejection device introduces the reaction byproduct into contact with the chemical composition capable of oxidative reaction in a stoichiometric relationship appropriate for function of the electrochemical cell.

34. The electrochemical system of claim 33 wherein the fuel supply apparatus further comprises an electronically controlled nozzle member in fluid communication with a fluid storage chamber.

35. The electrochemical system of claim 31 further comprising at least one sensor detecting a product of the oxidative reaction occurring in the electrochemical cell.

36. The electrochemical system of claim 34 further comprising an external interface device, the external interface device receiving an input command from a source external to the device, the input command actionable on the drop ejection device.

37. The electrochemical system of claim 36 further comprising an admixer in fluid communication with the nozzle member, the admixer configured to receive the chemical composition capable of oxidative reaction and at least one additional material and to initiate admixture of the received materials.

38. The electrochemical system of claim 27 further comprising:
a channel for removing at least one reaction byproduct from the electrochemical cell, the channel communicating with the associated electronically controllable drop ejection device, wherein the associated electronically controllable drop ejection device introduces the reaction byproduct into contact with the composition capable of oxidative reaction in a stoichiometric relationship appropriate for function of the electrochemical cell.

39. The electrochemical system of claim 38 wherein the drop ejection device includes at least one electronically controllable nozzle member.

40. The electrochemical system of claim 27 further comprising an external interface device, the external interface device receiving an input command from a source external to the device, the input command actionable on the drop ejection device.

41. The electrochemical system of claim 27 wherein the drop ejection device further comprises at least one resistor, the resistor having a surface which is reactive with at least one component of the composition capable of oxidative reaction.

42. The electrochemical system of claim 41 wherein the reactive surface of the resistor has at least one catalytic material imparted thereon, the catalytic material capable of supporting at least partial catalytic reformation of at least one component of the composition capable of oxidative reaction.

43. A power generator comprising:
an electrochemical cell having at least one reactive surface;
an electronically controllable jetting device supplying a fuel to the at least one reactive surface in the electrochemical cell; and
a recirculating circuit configured to convey a portion of at least one chemical byproduct produced in the electrochemical cell into reintegrative contact with the fuel.

44. The power generator of claim 43 wherein the electronically controllable jetting device comprises:
a reservoir containing a fuel capable of oxidative reaction;
a nozzle member in communication with the reservoir; and
a controller operable on the nozzle member, the controller regulating ejection of discrete volumes of fuel composition into the electrochemical cell.

45. The power generator of claim 44 wherein the jetting device further comprises at least one resistor surface, the resistor surface having at least one catalytic material positioned thereon, the catalytic material reactive with at least one component of the fuel to initiate at least partial catalytic reforming of at least one component of the fuel prior to entry into the electrochemical cell.

46. The power generator of claim 44 further comprising a regulator, the regulator operable on the recirculating circuit to deliver measured quantities of recirculated byproduct into contact with the fuel in at a specified ratio range, the specified ratio range being one which will facilitate oxidative reaction processes proceeding in the electrochemical cell.

47. The power generator of claim 43 further comprising an admixer in fluid communication with the drop ejection device, the mixing tank configured to receive the fuel and at least one additional material and initiate admixture of the received materials.

48. A device comprising:
a storage chamber containing a fuel;
an electrochemical cell associated with the fuel storage chamber;
an electronically controllable jetting device for delivering discrete quantities of fuel from the storage chamber to the electrochemical cell;
a recirculation circuit transporting at least a portion of a byproduct material produced in the electrochemical cell into contact with the fuel delivered from the storage chamber; and
a power consuming device powered by the electrochemical cell.

49. The device of claim 48 wherein the jetting device includes an electronically controllable nozzle member.

50. The device of claim 49 wherein the storage chamber includes at least two storage compartments, one compartment adapted to contain the fuel and an additional compartment adapted to contain at least one component which is complimentary to the oxidative process occurring in the electrochemical cell.

51. A method for delivering a primary material to an electrochemical cell comprising the step of ejecting a quantity of primary material from an electronically controllable drop ejection device, the quantity of fluid ejected being determined by at least one of consumption demands of the electrochemical cell, composition of the primary material, composition of additional material introduced into the electrochemical cell, and quantity of additional material introduced into the electrochemical cell contemporaneous with the ejection of the material.

52. The method of claim 51 wherein the primary material is a composition which contains at least one compound capable of undergoing oxidative reaction upon introduction into the electrochemical cell.

53. The method of claim 51 wherein the primary material is a fuel.

54. The method of claim 51 wherein the additional material is an additive complimentary with the fuel.

55. The method of claim 54 further comprising the step of ejecting a quantity of additional material from an additional electronically controllable drop ejection device, the quantity of additional fluid ejected being in proportionate relationship with the quantity of primary material ejected.

56. The method of claim 52 further comprising the step of integrating a byproduct of oxidative reaction occurring in the electrochemical cell into the primary material.

57. The method of claim 56 wherein the byproduct oxidative reaction is conveyed to a drop ejection device for ejection at a rate proportionate to ejection of the primary material.

58. The method of claim 54 further comprising the step of partially reforming at least one component of at least one of the primary material and the additional material.

59. The method of claim 58 wherein partial reformation is initiated by contact with at least one resistor present in the drop ejection device.

60. The method of claim 59 wherein the resistor includes at least one material which catalyzes partial reformation.

61. A method for initiating reaction of a chemical compound comprising the steps of:
introducing a chemical compound into at least one fluid chamber located in a drop ejection nozzle member;
exposing the chemical compound to a catalyst located in the fluid chamber in a manner which initiates a catalytic reaction;
ejecting the chemical compound from the fluid chamber after initiation of the catalytic reaction.

62. The method of claim 61 further comprising the step of exposing the chemical compound introduced into the fluid chamber to an elevated temperature sufficient to facilitate catalysis.

63. The method of claim 61 wherein the catalytic reaction proceeds for an interval after the ejection step.

64. The method of claim 63 wherein the catalytic reaction is integrated into a multi-step chemical process.

65. The method of claim 61 wherein the catalytic reaction involves partial reformation of the chemical compound.

66. The method of claim 65 wherein the chemical compound is capable of undergoing oxidative reaction.

67. The method of claim 61 further comprising the step of delivering the chemical compound to an end use destination.

68. The method of claim 67 wherein the end use destination is an electrochemical cell.

69. The method of claim 67 wherein the end use destination is an analytical device.

70. The method of claim 67 wherein the end use destination is a supplemental chemical compound.

71. A device comprising:
means for emitting quantities of at least two materials from respective sources, the emitting means capable of generating a composition in which the at least two materials are in a stoichiometric relationship suitable for function of an electrochemical cell.

72. The device of claim 71 further comprising:
means for removing a byproduct of reaction occurring in the electrochemical cell and reintegrating the byproduct into the stoichiometric composition in an electronically controllable manner.
